(19) United States
(12) Patent Application Publication
(10) Pub. No.: US 2023/0331189 A1
(43) Pub. Date: Oct. 19, 2023

(54) METHOD AND APPARATUS FOR CONTROLLING DOOR SYSTEM OF VEHICLE

(71) Applicants: Hyundai Motor Company, Seoul (KR); Kia Corporation, Seoul (KR)

(72) Inventor: Sung Hon BAIG, Hwaseong-Si (KR)

(73) Assignees: Hyundai Motor Company, Seoul (KR); Kia Corporation, Seoul (KR)

(21) Appl. No.: 17/945,768

(22) Filed: Sep. 15, 2022

(30) Foreign Application Priority Data
Apr. 19, 2022 (KR) 10-2022-0047880

(51) Int. Cl. G06V 40/20; B60R 25/30; B60R 25/24

(52) U.S. Cl. CPC B60R 25/305; B60R 25/24; G06V 40/25

(57) ABSTRACT

A method and an apparatus of controlling a door system of a vehicle are provided. It is possible to open or lock the door system of the vehicle using a gait pattern of a vehicle user. Furthermore, it is determined that there is no user in a vehicle when a smart key is not present inside the vehicle with a vehicle door being opened by a user’s gait pattern, thus changing the opened vehicle door into the locked state and thereby further strengthening a safety function against vehicle theft.

### CROSS REFERENCE TO RELATED APPLICATION

The present application claims priority to Korean Patent Application No. 10-2022-0047880, filed Apr. 19, 2022, the entire contents of which is incorporated herein for all purposes by this reference.

### BACKGROUND OF THE PRESENT DISCLOSURE

### Field of the Present Disclosure

The present disclosure relates to a method and an apparatus of controlling a door system of a vehicle. More particularly, the present disclosure relates to a method and an apparatus of controlling a door system of a vehicle, the method and apparatus being intended to open or lock the door system of the vehicle using a gait pattern of a vehicle user (driver).

### Description of Related Art

A vehicle is provided with a door that opens or closes to allow a vehicle user (driver) to get in or out of the vehicle. The door of the vehicle is maintained in an open or locked state through operation of a door system including a locking device.

To operate the door system of the vehicle, the user touches his or her finger on a sensing portion of a door handle while possessing a smart key or presses a button of the smart key to operate the door system remotely.

However, when the user holds a load in both hands, so that the user cannot touch his or her finger on the sensing portion of the door handle or does not operate the button of the smart key, it is difficult to operate the door system of the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and an apparatus of controlling a door system of a vehicle, the method and apparatus being intended to open or lock the door system of the vehicle using a gait pattern of a vehicle user, thus improving the convenience of use and strengthening security.

Furthermore, another objective of the present disclosure is to determine that there is no user in a vehicle when a smart key is not present inside the vehicle with a vehicle door being opened by a user’s gait pattern, thus changing the opened vehicle door into the locked state and thereby further strengthening a safety function against vehicle theft.

To achieve the objectives of the present disclosure, the present disclosure provides a method of controlling a door system of a vehicle, the method including a determination step of determining whether a real-time gait pattern of a user obtained in real time when the user approaches the vehicle and a registered gait pattern of the user registered in the controller match each other; and an open step of opening the door system of the vehicle, when the controller concludes that the real-time gait pattern and the registered gait pattern match each other.

The method may further include a locking step of maintaining the door system of the vehicle in a locked state, when the controller concludes that the real-time gait pattern and the registered gait pattern do not match each other.

The method may further include a detection step of detecting a smart key inside the vehicle after the open step, and the door system of the vehicle may maintain an open state, when the smart key is detected inside the vehicle.

The door system of the vehicle may be changed from an open state to a locked state, when the smart key is not detected inside the vehicle.

The method may further include a recognition step of recognizing the gait pattern of the vehicle user using a camera sensor of the vehicle before the determination step; a registration step of storing and registering the recognized gait pattern of the user in a vehicle controller; and an operation step of turning on an operation of the door system of the vehicle using the gait pattern after the registering of the gait pattern is completed.

The recognition step and the registration step may be executed by control of the vehicle controller, in response that the user operates an input switch provided in the smart key.

The recognition step may be executed in response that the user initially operates the input switch once, and the registration step may be executed when the user operates the input switch again in a state where the recognition step is executed.

The operation step may be executed by the control of the vehicle controller when the user operates an actuation switch provided in the smart key.

The real-time gait pattern of the user may be obtained in real time by the camera sensor of the vehicle.

Furthermore, the present disclosure provides an apparatus of controlling a door system of a vehicle including a camera sensor of a vehicle recognizing and obtaining a gait pattern of a vehicle user; a door system of the vehicle operated to open and lock a vehicle door; and a vehicle controller storing and registering the gait pattern of the vehicle user, determining whether a real-time gait pattern of the user obtained in real time by the camera sensor when the vehicle user approaches the vehicle and a registered gait pattern of the user match each other, and controlling an operation of the door system according to a result of the determining.

The apparatus may further include a smart key including an input switch that generates a signal to the vehicle controller when the user operates the input switch, and the input switch may generate a recognition signal to recognize the gait pattern of the vehicle user by the camera sensor, and a registration signal to store and register the recognized gait pattern of the user in the vehicle controller.

The recognition signal may be generated when the user initially operates the input switch once, and the registration signal may be generated when the user operates the input switch again after the recognition signal is generated.

The apparatus may further include a smart key including an actuation switch that generates a signal to the vehicle controller when the user operates the actuation switch, and the actuation switch may generate an actuation signal that turns on an operation of the door system to start operating the vehicle door system using the gait pattern.

The camera sensor may include a plurality of front camera sensors and a plurality of rear camera sensors to recognize and obtain external environment of the vehicle.

A method and an apparatus of controlling a door system of a vehicle according to an exemplary embodiment of the present disclosure are configured to open or lock the door system of the vehicle using a gait pattern of a vehicle user, thus improving the convenience of use and strengthening security.

Furthermore, according to an exemplary embodiment of the present disclosure, it is determined that there is no user in a vehicle when a smart key is not present inside the vehicle with a vehicle door being opened by a user’s gait pattern, thus changing the opened vehicle door into the locked state and thereby further strengthening a safety function against vehicle theft.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

The above and other objectives, features, and other advantages of the present disclosure when taken in conjoint with the accompanying drawings, in which:

FIG. 1 and FIG. 2 are a schematic block diagram and a flowchart illustrating a method and an apparatus of controlling a door system of a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural or functional descriptions in the exemplary embodiments of the present disclosure included in the present specification or application are only for description of the embodiments of the present disclosure. The descriptions should not be construed as being limited to the embodiments described in the specification or application.

Since the present disclosure may be embodied in many different forms, various exemplary embodiments will be illustrated in the drawings and be described in detail herein. However, it is to be understood that the present description is not intended to limit the present disclosure to those exemplary embodiments of the present disclosure, and the present disclosure is intended to cover not only the exemplary embodiments of the present disclosure, but also various alternatives, modifications, equivalents and other embodiments that fall within the spirit and scope of the present disclosure.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it may be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to” should be construed in the same way.

The terminology used herein is for describing various exemplary embodiments only and is not intended to be limiting. In the present disclosure, the singular forms are intended to include the plural forms as well, unless the context clearly indicates otherwise. It will be further understood that the terms “comprise”, “include”, “have”, etc. When used in the present specification, specify the presence of stated features, integers, steps, operations, elements, components, and/or combinations thereof but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning which is consistent with their meaning in the context of the present specification and the relevant art and will not be interpreted in an idealized or overly formal sense unless so defined herein.

A control unit (controller) according to an exemplary embodiment of the present disclosure may be implemented through a non-volatile memory configured to store an algorithm configured to control the operation of various components of a vehicle or data on a software command playing the algorithm, and a processor configured to perform an operation that will be described below using the data stored in a corresponding memory. Here, the memory and the processor may be implemented as separate chips. Alternatively, the memory and the processor may be implemented as a single integrated chip. The processor may take the form of one or more processors.

Hereinafter, a method and an apparatus of controlling a door system of a vehicle according to an exemplary embodiment of the present disclosure will be described in detail with reference to the accompanying drawings.

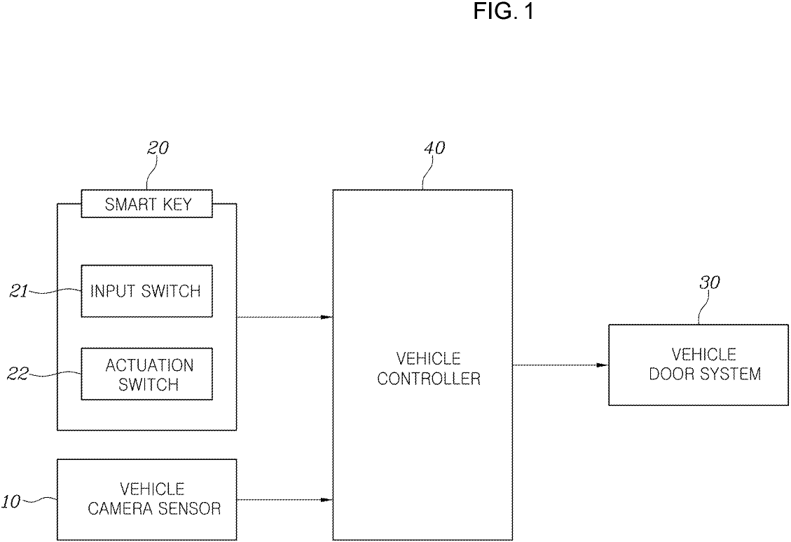

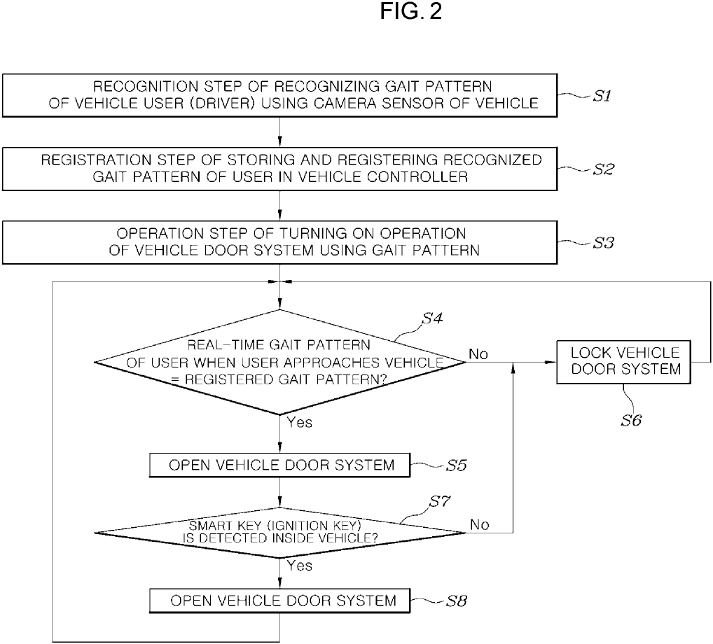

FIG. 1 and FIG. 2 are a schematic block diagram and a flowchart illustrating a method and an apparatus of controlling a door system of a vehicle according to an exemplary embodiment of the present disclosure.

As shown in the drawings, the apparatus according to an exemplary embodiment of the present disclosure includes a camera sensor 10 of a vehicle recognizing and obtaining a gait pattern of a vehicle user (driver), a door system 30 of the vehicle operated to open and lock a vehicle door, and a vehicle controller 40 storing and registering the gait pattern of the vehicle user, determining whether a real-time gait pattern of the user obtained in real time by the camera sensor 10 when the vehicle user approaches the vehicle and a registered gait pattern of the user match each other, and controlling an operation of the door system 30.

The camera sensor 10 includes a plurality of front camera sensors and a plurality of rear camera sensors to recognize and obtain an external environment of the vehicle.

The plurality of front camera sensors and rear camera sensors may recognize and obtain an external environment in front of the vehicle, an external environment in back of the vehicle, as well as an external environment on a side of the vehicle, thus allowing the gait pattern of the user approaching the vehicle to be precisely recognized and obtained.

Furthermore, an exemplary embodiment of the present disclosure further includes a smart key (ignition key) 20 that generates a signal to the vehicle controller 40, and the vehicle controller 40 may detect the smart key 20 inside the vehicle through a unique signal generated in the smart key 20.

The smart key 20 includes an input switch 21 and an actuation switch 22 that generate signals to the vehicle controller 40 when the user operates the switches.

When the user initially operates the input switch 21 once, the recognition signal is generated. When the recognition signal is generated, the camera sensor 10 of the vehicle recognizes and obtains the gait pattern of the vehicle user approaching the vehicle.

When the gait pattern of the user is recognized by the camera sensor 10, the user operates the input switch 21 again. At the instant time, the registration signal is generated. When the registration signal is generated, the gait pattern of the user recognized by the camera sensor 10 is stored and registered in the vehicle controller 40.

The gait pattern of the user registered in the vehicle controller 40 may be eliminated by operating the switch of the smart key 20, and thereby the registration of the gait pattern may be initialized.

When the registration of the user’s gait pattern has been completed in the vehicle controller 40, the user operates the actuation switch 22 of the smart key 20, and the vehicle controller 40 receives the signal of the actuation switch 22 and turns on the operation of the door system to start operating the vehicle door system 30 using the gait pattern.

On the other hand, unless the user operates the actuation switch 22, the vehicle controller 40 turns off the operation of the door system so that the vehicle door system 30 using the gait pattern is not operated. In the instant case, a control logic according to an exemplary embodiment of the present disclosure is completed.

A method of controlling a door system of a vehicle according to an exemplary embodiment of the present disclosure will be described with reference to FIG. 2.

A user first operates the input switch 21 of the smart key 20 once to generate a recognition signal. When the recognition signal is generated, a recognition step S1 in which the camera sensor 10 of the vehicle recognizes the gait pattern of the user approaching the vehicle is executed.

After the recognition step S1 is executed, the user operates the input switch 21 of the smart key 20 again to generate a registration signal. When the registration signal is generated, a registration step S2 in which the user’s gait pattern recognized by the camera sensor 10 is stored and registered in the vehicle controller 40 is executed.

After the registration step S2 is executed, the user operates the actuation switch 22 of the smart key 20 to generate the actuation signal. When the actuation signal is generated, an operation step S3 in which the vehicle controller 40 turns on the operation of the door system to start operating the vehicle door system 30 using the gait pattern is executed.

Unless the user operates the actuation switch 22 of the smart key 20, the vehicle controller 40 turns off the operation of the door system so that the vehicle door system 30 using the gait pattern is not operated. In the instant case, the control logic according to an exemplary embodiment of the present disclosure is completed.

If the vehicle user approaches the vehicle after the operation step S3 is executed, a determination step S4 of determining whether a real-time gait pattern of a user obtained in real time by the camera sensor 10 of the vehicle and a registered gait pattern of the user registered in the vehicle controller 40 match each other is executed.

The determination step S4 is executed in the vehicle controller 40.

When it is determined in the determination step S4 that the real-time gait pattern and the registered gait pattern match each other, an open step S5 in which the door system 30 of the vehicle is automatically opened by the control of the vehicle controller 40 is executed. Accordingly, it is possible to improve the convenience of use.

However, when it is determined in the determination step S4 that the real-time gait pattern and the registered gait pattern do not match each other, a locking step S6 in which the door system 30 of the vehicle is maintained in a locked state by the control of the vehicle controller 40 is executed. Accordingly, it is possible to strengthen security.

When a predetermined time period (about 3 to 5 seconds) has passed after the open step S5 is executed, a detection step S7 in which the smart key 20 inside the vehicle is detected by the vehicle controller 40 is executed.

When the smart key 20 inside the vehicle is detected in the detection step S7, the door system 30 of the vehicle is maintained in an open state by the vehicle controller 40 (step S8). On the other hand, when the smart key 20 inside the vehicle is not detected, the logic of the present disclosure is fed back to step S6, so that the door system 30 of the vehicle is changed from the open state into the locked state.

By the user’s gait pattern when the vehicle user approaches the vehicle, a case where the smart key 20 is not present inside the vehicle when the vehicle door is opened is determined that there is no user in the vehicle. In the instant case, a safety function against vehicle theft may be further strengthened by changing the opened vehicle door into the locked state.

As described above, an exemplary embodiment of the present disclosure is configured to open or lock the door system 30 of the vehicle using the gait pattern of the vehicle user, thus improving the convenience of use and strengthening security.

Furthermore, according to an exemplary embodiment of the present disclosure, it is determined that there is no user in the vehicle when the smart key 20 is not present inside the vehicle with the vehicle door being opened by the user’s gait pattern, thus changing the opened vehicle door into the locked state and thereby further strengthening a safety function against vehicle theft.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling a door system of a vehicle, the method comprising:
determining, by a controller, whether a real-time gait pattern of a user obtained in real time when the user approaches the vehicle and a registered gait pattern of the user registered in the controller match each other; and
opening, by the controller, the door system of the vehicle, when the controller concludes that the real-time gait pattern and the registered gait pattern match each other.

2. The method of claim 1, further including:
maintaining, by the controller, the door system of the vehicle in a locked state, when the controller concludes that the real-time gait pattern and the registered gait pattern do not match each other.

3. The method of claim 1, further including:
detecting, by the controller, a smart key inside the vehicle after the opening of the door system,
wherein the controller is configured to maintain the door system in an open state, when the controller concludes that the smart key is detected inside the vehicle.

4. The method of claim 3, wherein the controller is configured for detecting the smart key inside the vehicle in a predetermined time period after the opening of the door system.

5. The method of claim 3, wherein the controller is configured to change the door system of the vehicle from the open state to a locked state, when the controller concludes that the smart key is not detected inside the vehicle.

6. The method of claim 1, further including:
recognizing, by the controller, a gait pattern of the user using a camera sensor of the vehicle before the determining;
storing and registering, by the controller, the recognized gait pattern of the user in the controller as the registered gait pattern; and turning on, by the controller, an operation of the door system of the vehicle using the registered gait pattern after the registering of the gait pattern is completed.

7. The method of claim 6, wherein the recognizing and the registering are executed by control of the controller, in response that the user operates an input switch provided in a smart key.

8. The method of claim 7, wherein the recognizing is executed in response that the user initially operates the input switch once, and the registering is executed in response that the user operates the input switch again in a state where the recognizing is executed.

9. The method of claim 6, wherein the turning on the operation of the door system is executed by the controller in response that the user operates an actuation switch provided in a smart key.

10. The method of claim 1, wherein the real-time gait pattern of the user is obtained in real time by a camera sensor of the vehicle.

11. An apparatus of controlling a door system, the apparatus comprising:
a camera sensor of a vehicle configured for obtaining a gait pattern of a user;
the door system of the vehicle configured to open or lock a vehicle door; and
a controller configured for storing and registering the gait pattern of the user, determining whether a real-time gait pattern of the user obtained in real time by the camera sensor when the user approaches the vehicle and a registered gait pattern of the user match each other, and controlling an operation of the door system according to a result of the determining.

12. The apparatus of claim 11, wherein the controller is configured for opening the door system of the vehicle, when the controller concludes that the real-time gait pattern and the registered gait pattern match each other.

13. The apparatus of claim 12, further including:
a smart key including an input switch that is configured to generate a signal to the controller in response that the user operates the input switch,
wherein the input switch is configured to generate a recognition signal to recognize the gait pattern of the user by the camera sensor, and a registering signal to store and register the recognized gait pattern of the user, as the registered gait pattern, in the controller in the response that the user operates the input switch.

14. The apparatus of claim 13, wherein the recognition signal is generated in response that the user initially operates the input switch once, and the registering signal is generated in response that the user operates the input switch again after the recognition signal is generated.

15. The apparatus of claim 12, further including:
a smart key including an actuation switch that is configured to generate a signal to the controller in response that the user operates the actuation switch,
wherein the actuation switch is configured to generate an actuation signal for the controller to turn on the operation of the door system to start operating the door system using the real-time gate pattern and the registered gait pattern.

16. The apparatus of claim 12, wherein the camera sensor includes a plurality of front camera sensors and a plurality of rear camera sensors to obtain external environment of the vehicle.

17. The apparatus of claim 12, wherein the controller is configured for maintaining the door system of the vehicle in a locked state, when the controller concludes that the real-time gait pattern and the registered gait pattern do not match each other.

18. The apparatus of claim 12, wherein the controller is configured for detecting a smart key inside the vehicle after the opening of the door system,
wherein the controller is configured to maintain the door system in an open state, when the controller concludes that the smart key is detected inside the vehicle.

19. The apparatus of claim 18, wherein the controller is configured to change the door system of the vehicle from the open state to a locked state, when the controller concludes that the smart key is not detected inside the vehicle.

20. The apparatus of claim 12, wherein the controller is configured for:
recognizing the gait pattern of the user using the camera sensor of the vehicle before the determining;
storing and registering the recognized gait pattern of the user in the controller, as the registered gain pattern; and
turning on the operation of the door system of the vehicle using the real-time gate pattern and the registered gait pattern after the registering of the recognized gait pattern is completed.
